(19) United States
(12) Patent Application Publication
(10) Pub. No.: US 2020/0061806 A1
(43) Pub. Date: Feb. 27, 2020

(54) HANDLING PARTS IN A PRESS LINE

(71) Applicant: ABB SCHWEIZ AG, Baden, (CH)

(72) Inventors: Roger PONS BERTRAN, La Torre De Claramunt (ES); Antonio-Lorenzo VIÑUALES DUESA, Barcelona (ES); Esteve BOLTA TOBELLA, Sant Esteve De Sesrovires (ES); Ramon CASANELLES MOIX, Sant Cugat Del Vallès (ES)

(73) Assignee: ABB SCHWEIZ AG, Baden (CH)

(21) Appl. No.: 16/314,355

(22) PCT Filed: Jun. 30, 2016
(86) PCT No.: PCT/EP2016/065275

§ 371 Date: Dec. 28, 2018

(51) Int. Cl. B25J 9/00; B25J 9/04; B21D 43/05

(52) U.S. Cl. CPC B25J 9/0093; B21D 43/05; B25J 9/042

(57) ABSTRACT

A system (100) for handling parts (300) in a press line comprises two industrial robots (101a, 101b) and at least one control unit (400) for the control of the robots, wherein each industrial robot is an articulated robot with at least four axes mounted in series between a robot base (2) and a robot wrist (3), wherein each industrial robot further comprises an arm (4) that has a proximal end (4a) fixed to the robot wrist (3) and a distal end (4b) carrying an additional rotational axis (A7), a motor (43) mounted on the arm near the proximal end, and a transmission (41) between the motor and the additional rotational axis. A method for handling parts in a press line may comprise operating the system such that the two robots jointly handle a part, or such that they each handle a part, either in an alternating or in a parallel mode.

The present developments are related to a system for handling parts, for example for unloading parts from a press and/or loading parts to a press in a press line, and especially for inter-press handling in stamping press lines.

### BACKGROUND

It is known to use industrial robots for loading and unloading workpieces or parts in a press line, such as those employed for manufacturing vehicle bodywork parts.

In press lines it is advisable to keep cycle speed as high as possible. The cycle time involves the time the press needs to conform the workpiece, plus the time during which the press stays open while the robots unload or remove one part from the press, and load or insert the next part. Furthermore, if the transfer of the workpiece from one press to another is slow it may become a bottleneck, and then the cycle time is increased because the press needs to wait for the workpiece.

It is therefore advisable to reduce as much as possible the time required for loading and unloading the presses, and also avoid that the time required to transfer the workpieces from one press to another becomes a bottleneck for the process.

Cycle speed may be increased for example by extracting and inserting parts linearly with respect to the presses in the direction of the press line.

It is also desirable to transfer the parts between presses with a substantially rectilinear trajectory in the direction of the press line, and maintaining the orientation of the parts instead of rotating them during the transfer.

At the same time, there are other aspects that need to be taken into account for efficient and safe handling of the parts, such as for example limiting the height of the gripper and other elements of the handling robots that enter a press during loading/unloading, and make them of low hardness materials in order to reduce the damage to the press in case of an accident.

Further desirable aspects of the handling operations are reducing the risk of collisions and increasing the possibility of handling parts of large dimensions and of handling more than one part simultaneously.

When the bottleneck may be the transfer between presses it is known to use handling systems having a pair of articulated robots for the loading and unloading operation, such that a robot may unload a part from a first press and load it to a second press while the other robot returns empty from the second press to the first to handle the next part.

A problem arising with such systems is that there is a high risk of interference between the robots during the transfer and severe limitations to the transfer paths that can be performed by the robots. In some cases, for example if the distance between presses is relatively small, interference makes it impossible to use a system with two articulated robots.

The extraction and insertion of the part with respect to the press may also take longer, because it may require a movement that is not rectilinear and in the direction of the press line.

As a consequence, the potential benefit of using a system with two robots may be reduced, and instead of increasing the speed by a factor close to 2, in many cases the speed may be e.g. around 1.5 or even less with respect to using a single robot.

On the other hand it is known to use systems with two robots to handle a part between them, for example, two robots may be used for jointly handling parts, in order for example to load and unload parts between presses following a rectilinear trajectory. The robots may be articulated 4-axis or 6-axis robots, and each has an auxiliary arm coupled to its wrist and having a freely rotating swivel joint at its free end.

A crossbar may be mounted between the swivel joints of the auxiliary arms of the two robots. The crossbar acts as a permanent mechanical link between the robots, and has a gripper attached to it for picking the parts to be loaded and unloaded.

However the crossbar adds to the height and rigidity of the elements that enter into the press for loading and unloading, and this increases both the time required for the operation, and the risk of damage to the press in case of an accident.

The two robots may also work jointly on a part to be handled without using a crossbar, by providing each robot with a gripper attached to the swivel joint of the arm. In this case the two grippers engage the part to be handled, and the part itself provides a mechanical link between the two robots. However, after the part is loaded in a press and released by the grippers, the mechanical link is lost and the swivel joints are free to rotate and therefore the position of the gripper can no longer be controlled.

It has now been found that it is possible to provide an improved system for handling parts, for example for unloading parts from a press and/or loading parts to a press in a press line, which allows working in several modes and may be more efficient than known solutions.

### SUMMARY

According to a first aspect, the present developments provide a system for handling parts in a press line including two industrial robots and at least one control unit for the control of the robots, each industrial robot being an articulated robot with at least four axes mounted in series between a robot base and a robot wrist, each industrial robot further including an arm that has a proximal end fixed to the robot wrist and a distal end carrying an additional rotational axis, a motor mounted on the arm near the proximal end, and a transmission between the motor and the additional rotational axis.

The provision of a system with two articulated robots having an arm fixed to the robot wrist and an additional rotational axis at the distal end results in a very versatile system, with several possible working modes depending on the different parts to be manufactured in the press line, and in each case it has significant advantages over known handling systems.

For example, a large part may be handled jointly by the two robots maintaining the control at all times and without the need for a crossbar, and this allows a significant reduction of the height of the elements that enter the presses and of the risk of damage in case of an accident.

The system may also be employed to transfer parts faster from one press to another by using each robot to handle one part.

In this case, the operation may involve an “alternating” mode of operation with one robot taking one part from a first to a second press while the other robot is returning empty from the second press to the first. It may also involve a “parallel” mode of operation, if the press line is employed for stamping in the press several parts at the same time, for example two parts, or even four parts. In this case, both robots may operate in parallel between two presses, each carrying one of the two parts, or two or the four parts.

In the alternating or parallel modes as defined above, the kinematic chain resulting from the additional rotational axis at the distal end of the arm allows to unload the parts from a press linearly, in the direction of the press line; transfer them to the next press also following a substantially rectilinear path; and load them in the next press also linearly, in the same direction. It also allows shifting of the parts during the transfer from one press to the other, i.e. handling parts that in one press are placed at a certain distance between them and in the next press are placed at a different distance between them.

Furthermore, the system reduces the problems of potential interference between the robots which occur with 6-axes robots, because the wrists of the two robots may be maintained spaced apart during the movement, and the additional axes cause less interference issues because they are not bulky, due to the motor being mounted at the proximal end of the arm and not at the distal end.

In summary, the system is extremely versatile, and allows working in all cases with high cycle speeds, gaining a larger benefit from the use of two robots than in prior systems, because of the more efficient loading and unloading operations and because the smaller risk of interference between moving elements allows more efficient trajectories between presses.

According to a further aspect, the developments here provide methods for handling parts in a press line.

In another aspect, a method for handling parts in a press line is disclosed, including providing two industrial robots and at last one control unit for the control of the robots, each industrial robot being an articulated robot with at least four axes arranged in series between a robot base and a robot wrist, each industrial robot further having an arm that has a proximal end fixed to the robot wrist and a distal end carrying an additional rotational axis, a motor mounted on the arm near the proximal end, and a transmission between the motor and the additional rotational axis.

In a further aspect, a computer program product is disclosed. The computer program product may include program instructions for causing a computing system to perform a method for handling parts in a press line according to some examples disclosed herein.

The computer program product may be embodied on a storage medium (for example, a CD-ROM, a DVD, a USB drive, on a computer memory or on a read-only memory) or carried on a carrier signal (for example, on an electrical or optical carrier signal).

The computer program may be in the form of source code, object code, a code intermediate source and object code such as in partially compiled form, or in any other form suitable for use in the implementation of the processes. The carrier may be any entity or device capable of carrying the computer program.

For example, the carrier may include a storage medium, such as a ROM, for example a CD ROM or a semiconductor ROM, or a magnetic recording medium, for example a hard disk. Further, the carrier may be a transmissible carrier such as an electrical or optical signal, which may be conveyed via electrical or optical cable or by radio or other devices or systems or methods.

When the computer program is embodied in a signal that may be conveyed directly by a cable or other device or system or method, the carrier may be constituted by such cable or other device or system or method.

Alternatively, the carrier may be an integrated circuit in which the computer program is embedded, the integrated circuit being adapted for performing, or for use in the performance of, the relevant methods.

Additional objects, advantages and features of embodiments of the inventions hereof will become apparent to those skilled in the art upon examination of the description, or may be learned by practice of the inventions.

### BRIEF DESCRIPTION OF THE DRAWINGS

Particular embodiments of the present developments will be described in the following by way of non-limiting examples, with reference to the appended drawings, in which:

FIG. 1 is a schematic perspective view of a system for handling workpieces in a press line according to the present developments;

FIG. 2 is a schematic view of an arm with an additional rotational axis, fixed to a robot wrist of the system of FIG. 1;

FIGS. 3A-3D show in plan view a sequence of the system of FIG. 1 in a first or alternating mode of operation;

FIGS. 4A-4D show in plan view a sequence of the system of FIG. 1 in a second or parallel mode of operation; and

FIGS. 5A-5D show in plan view a sequence of the system of FIG. 1 in a third or joint mode of operation.

### DETAILED DESCRIPTION

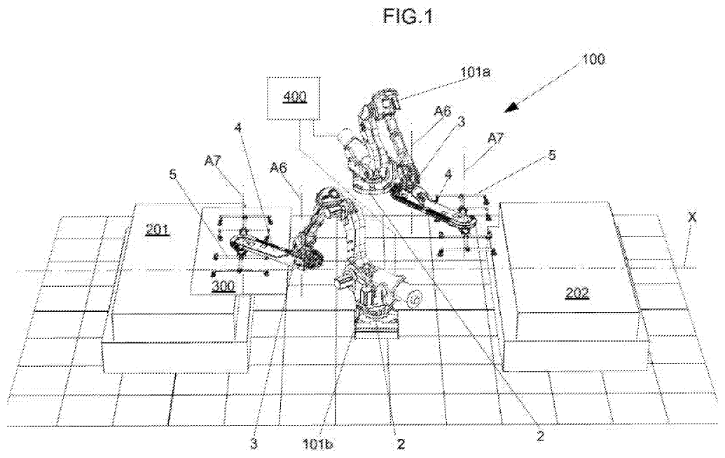

FIG. 1 shows a system 100 for handling workpieces in a press line, for example a multi-stage press line, of the kind employed for example for stamping metal parts 300 such as vehicle body parts.

The system of FIG. 1 may be employed for unloading parts 300 from a first station 201 in the press line, and transferring them to a second station 202 in the press line. The first and second stations 201, 202 in the press line may generally be presses, i.e. the system is intended especially, but not exclusively, for inter-press handling.

As shown in the attached figures the present system 100 may have two industrial robots 101a, 101b and at least one control unit 400 for the control of the robots 1. A single control unit may control the two robots 101a, 101b jointly. Control units that may operate robots jointly are for example those available from ABB (www.abb.com) which include the function MultiMove; MultiMove is a function embedded e.g. into ABB's IRC5 control module, that allows to control the axes of several manipulators (robots) such that they work like a single robot.

Alternatively, the control unit may include two controllers, one for each robot 101a, 101b, and suitable devices, systems or methods to synchronize the operation of the two robots 1.

The robots 101a, 101b may be articulated robots with at least four axes mounted in series between a robot base 2 and a robot wrist 3. In this example the robots 101a, 101b have six axes between the base and the wrist, and the additional axis is therefore a seventh axis, but the system may also be implemented using robots with a different number of axes between the base and the wrist, such as four, such that the additional axis would be a fifth axis. The amount of axes will depend on the specific requirements of each case.

The robots 101a, 101b may be directly fixed to a floor through the robot base 2 or it may be mounted on a supporting structure (not shown), roof mounted, etc.

The robots may be arranged in the space between the presses 201 and 202. As shown, they may be arranged one opposite the other, on either side of the centre line X in the direction of the press line.

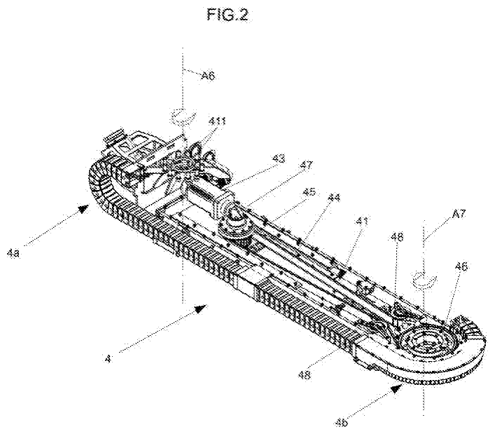

In the attached FIGS. 1 and 2 it can be seen that each industrial robot 101a, 101b may further include an arm 4 that has a proximal end 4a fixed to the robot wrist 3 and a distal end 4b carrying an additional rotational axis A7. Proximal and distal ends should be understood taking into account the robot wrist 3 as a reference. The arm 4 may be coupled to the axis A6 of the robot wrist 3 through a plurality of screw members 411. The skilled person could also implement any other known coupling arrangement to couple the arm 4 to the robot wrist 3 such that the arm 4 rotates together with axis A6.

The arm 4 may be shaped as an elongated body with a height substantially smaller than its width. Furthermore the height of the distal end of the arm 4, i.e. the dimension in the direction of the axis of rotation of the additional rotation axis A7, may be smaller than the height of the proximal end of the arm 4.

The arm 4 may also include a motor 43 mounted near the proximal end, and a transmission 41 between the motor 43 and the additional rotational axis A7. The motor 43 and transmission 41 may be of any known type.

As per FIG. 2 the additional rotational axis A7 may be parallel to the robot wrist rotational axis A6.

If an exemplary six-axes robot 101a, 101b has an arm 4 provided with the additional rotational axis A7 then the overall amount of rotational axes will be seven. The additional rotational axis A7 at the end of the arm 4 adds one rotational axis to the robot, but in a position at a distance from the robot wrist and the motors, and with a small height that is suitable to enter the press.

In FIG. 2 an exemplary arm 4 is shown wherein some members such as a cover have been removed to show the inner components thereof. In the example shown, the transmission 41 may be realized as a belt transmission. The motor 43 and a transmission belt 44, for example a toothed belt, may be placed longitudinally with respect to the length of the arm 4 so as to keep the height of the arm 4 as small as possible. The transmission belt 44 may extend between two pulleys 45 and 46, for example toothed pulleys. The pulley 45 may be driven by the motor 43 by a bevel gear 47 or the like, while the additional axis A7 may be attached to the pulley 46. The transmission 44 may further have belt tensioners 48 to allow a better operation of the apparatus.

In FIG. 1 it can be seen that the robots 101a, 101b may be provided with a gripper 5 or gripping element attached to the additional rotational axis A7, at the distal end 4b of the arm 4. This gripper 5 may have or be a mechanical, electromagnetic or vacuum gripping system suitable to handle the parts 300 to be loaded and unloaded.

Methods for handling parts in a press line as disclosed herein may include providing a handling system as disclosed above between two stations of the press line, for example between two presses.

In operation, the additional rotational axis of each robot, such as axis A7 in the example shown, may be controlled by the control unit to place the gripper in position for gripping parts from the first station, and to place the gripper in position to release parts in the second station: no mechanical link is therefore needed between the two robots in order to be able to control the position of the grippers, as was the case in prior systems without a crossbar.

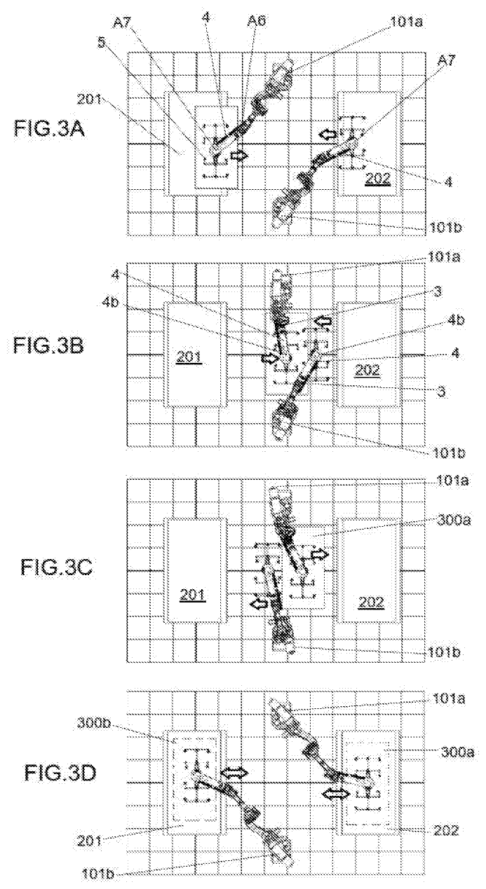

Examples of methods for handling parts in a press line according to different operating modes of a handling system as disclosed herein, for example the handling system 100 of FIGS. 1 and 2, are described in the following considering FIGS. 3 to 5.

In FIGS. 3A-3D, a method for handling parts according to a first mode of operation is illustrated, which is herein described as an “alternating” mode of operation because while one robot of the system is transferring a part from press to another, the other robot of the system is travelling in the opposite direction, to pick the following part from the first press.

In this case, the control unit 400 operates the two robots 101a, 101b such that one grips a first part at the first station 201 and transfers it to the second station 202, and subsequently the other robot does the same with another part: a robot returns from the second station to the first station empty while the other transfers a part from the first station to the second station. The unloading of the part, the transfer and the loading of the part are done in a substantially rectilinear trajectory in the direction of the press line, and maintaining the orientation of the part substantially constant.

In FIG. 3A, robot 101a having an arm 4 with axes A6 and A7 as disclosed above, is shown unloading a part 300a from a press 201 in the direction of the arrow, while robot 101b, also having an arm 4 and axes A6 and A7, has just loaded another part (not shown) in the following press 202 of the line, and is returning empty towards press 201, as shown by the arrow, for example under the control of the control unit 400 of FIG. 1, that controls all the movements of the robots, including those of the additional axis A7.

In FIG. 3B, the arms 4 of the robots 101a and 101b have advanced towards each other as shown by the respective arrows, and they are displaced vertically during their travel, so that they pass one over the other. For example, the arm 4 of robot 101a may be lowered, while arm 4 robot 101b is raised; alternatively, only one of the robots, for example robot 101b which carries an empty gripper, raises its arm 4 a distance that is sufficient to pass above the arm 4 of robot 101a. Other alternatives are also possible.

FIG. 3B shows that the wrists 3 of the two robots pass at a safe distance from each other, and only the distal ends 4b of the two arms 4, which are of small height, pass near each other. The risk of collision and the potential damage in case of an accident are therefore greatly reduced, and the vertical displacement of the arms that is needed so that they pass one over the other is relatively small.

FIG. 3C shows a position in which the arms 4 and corresponding grippers of the two robots 101a and 101b have travelled past each other and continue their movement: robot 101a transferring the part 300a towards press 202 and robot 101b travelling empty towards press 201.

FIG. 3D shows a position at the end of the movement, wherein robot 101a is loading the part 300a in press 202, while robot 101b is unloading a new part 300b from press 201. The arrows show that in this position both robots change their direction of travel.

The other half of the operating cycle (not shown) is symmetric to that shown in FIGS. 3A-3D: robot 101b transfers part 300b towards press 202 and loads it in this press, while robot 101a returns to press 201 with an empty gripper.

The sequence of FIGS. 3A-3D show clearly how a handling system as disclosed herein can unload, transfer and load parts 300 between two presses 201 and 202 in a very efficient way, without interference problems between the robots. The presence of the additional axes on the distal ends 4b of the arms 4 of the two robots allow loading and unloading the parts 300 following a straight line in the direction of the press line, and transfer them to the following press in the same direction and without rotation.

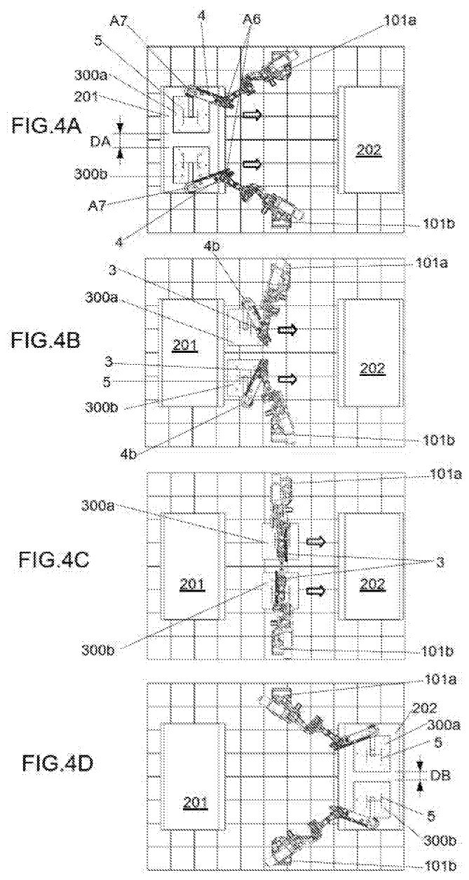

In FIGS. 4A-4D, a method for handling parts according to a second mode of operation is illustrated, which is herein described as a “parallel” mode of operation because both robots of the system are simultaneously transferring parts from one press to another.

This method may be used if the press line is stamping two or more parts in each press at the same time, and is particularly useful if the distance between the parts varies from one press to another, as will be explained in the following.

In this case, the control unit 400 operates the two robots 101a, 101b such that one grips a first part at the first station 201 and transfers it to the second station 202, and substantially simultaneously the other robot does the same with another part: both robots return substantially simultaneously from the second station to the first station, empty. The unloading of the parts, the transfer and the loading of the parts are done in a substantially rectilinear trajectory in the direction of the press line, and maintaining the orientation of the parts substantially constant.

In FIG. 4A, robot 101a having an arm 4 with axes A6 and A7 as disclosed above, is unloading a part 300a from a press 201 in the direction of the arrow, while robot 101b, also having an arm 4 and axes A6 and A7, is unloading another part 300b from the press 201 in the direction of the arrow, for example under the control of the control unit 400 of FIG. 1, that controls all the movements of the robots, including those of the additional axis A7.

In FIG. 4B, the arms 4 of the robots 101a, 101b have been moved forward following the direction of the arrows. Axes A6 and A7 are actuated by the control unit 400 to rotate respectively in a clockwise and/or counter-clockwise manner so that in the unloading operation the parts 300a, 300b follow a substantially linear path in the direction of the press line. Axes A6 and A7 may be operated so that the arms 4 pass between the wrist 3 and robot base 2, as shown. The wrists 3 of the two robots pass at a distance from each other that is closer than in the “alternating” mode, but is still a safe distance.

FIG. 4C shows another position of the cycle, at the point when the wrists 3 are closest to each other. A safe distance from each other is still maintained and therefore any interference between robots 101a, 101b may be avoided. As shown, the transfer of the parts between presses is also linear, in the direction of the press line.

FIG. 4D shows a position at the end of the movement wherein robot 101a may load part 300a and the robot 101b may load part 300b in press 202, both with a linear movement in the direction of the press line.

In order to unload new parts 300a, 300b from press 201, the robots 101a, 101b may go back towards press 201 with the same sequence of movements but in a reverse direction.

The sequence of FIGS. 4A-4D shows also that the versatility of the system with two robots 101a, 101b, allows loading the parts 300a, 300b at a predetermined relative distance DB from each other on the second station 202 which may be different from the relative distance DA at the first station 201. For example DA may be larger than DB (as shown in FIGS. 4A and 4D) or shorter. DA and DB could of course be the same.

The shift between the different distances DA and DB may be done by the robots for example during the transfer trajectory between the two presses.

The disclosed system is an improvement with respect to known solutions, such as a single robot gripping the two parts, or systems of two robots with a crossbar, because in the prior solutions an additional mechanism needs to be implemented in the gripper or crossbar to allow shifting of the parts between one press and the other.

FIGS. 4A-4D show only two parts 300a, 300b being stamped in each press simultaneously, but in some cases the parts are more, for example four parts. In this case each robot 101a, 101b would have a gripper suitable to simultaneously grip a pair of parts instead of a single part, but the operation of the system would be the same. Shifting between the two pairs could be done by the robots, as disclosed in the figures, and additional shifting mechanisms would only be required for shifting between the pair of parts gripped by one robot, if desired.

In the illustrated sequence 4A-4D the robots are operated such that the arms 4 pass between the wrist and the body of the robots. However, in some cases they may also be operated such that the arms rotate as depicted in FIGS. 3A-3D, and the wrists pass between the arm and the body of the robot: in this case, the wrists 3 can travel at a greater distance from each other, and only the distal ends 4b of the two arms 4, which are of small height, would travel near each other. In this case, the robots could be controlled so that the trajectory of the arms 4 of the two robots may be at different heights.

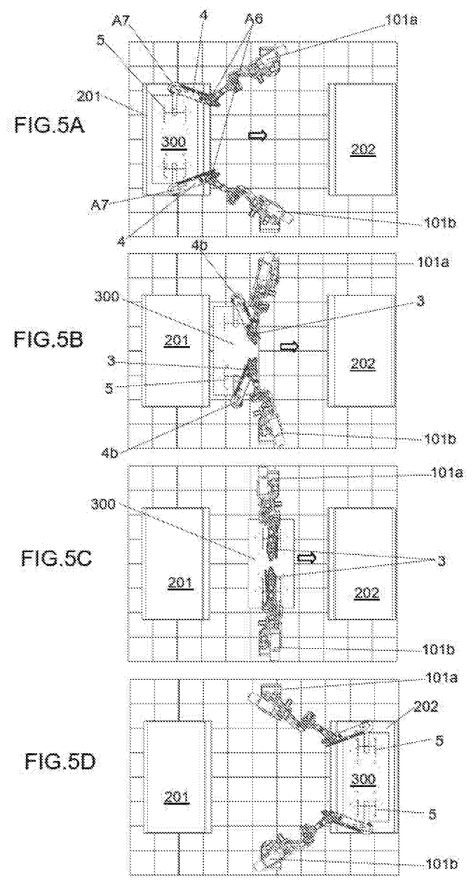

In FIGS. 5A-5D, a method for handling parts according to a third mode of operation is illustrated, which is herein described as a “joint” mode of operation because both robots of the system, operated by the control unit, cooperate to transfer the same part from press to another.

The control unit operates the two robots to jointly grip a part at the first station 201 and jointly transfer it with a substantially rectilinear trajectory to the second station 202, maintaining the orientation of the part substantially constant during the transfer.

This method may be used for example with large and/or heavy workpieces: if a single robot had to transfer such a large part, it would need to be a large robot, which would be bulky and slower than two smaller robots. In other words, by using two robots, smaller and faster robots may be used. Additionally, with the handling systems disclosed herein, the two robots do not need to be linked by a crossbar, and they can also be advantageously used with smaller parts, in the above disclosed alternating or parallel modes.

In FIG. 5A, robots 101a and 101b, each having an arm 4 with axes A6 and A7 as disclosed above, are jointly unloading a part 300a from a press 201 in the direction of the arrow. Both robots may be for example under the control of the control unit 400 of FIG. 1 which controls all the movements of the robots, including those of the additional axis A7.

In FIG. 5B, the arms 4 of the robots 101a, 101b have been moved forward following the direction of the arrow. Axes A6 and A7 are actuated by the control unit 400 to rotate respectively in a clockwise and/or counter-clockwise manner so as to keep the substantially linear path of part 300. In the present “joint” operation mode the arms 4 are moved so that the distal ends 4b of the two arms 4 pass between the wrist 3 and the robot base 2 in plan view. Similar to the “parallel” mode the wrists 3 of the two robots pass at a relative distance closer than in the “alternating” mode but still pass at a safe distance from each other.

FIG. 5C shows a position in which the arms 4 and corresponding grippers of the two robots 101a, 101b have travelled substantially half of the path between presses 201 and 202. A safe distance between the wrists 3 is kept and therefore any interference between robots 101a, 101b may be avoided.

FIG. 5D shows a position at the end of the movement wherein robots 101a, 101b may load jointly the part 300 in press 202.

In order to jointly unload a new part 300 from press 201, the robots 101a, 101b may travel back to press 201 with the same sequence of movements but in a reverse direction.

In the illustrated sequence 5A-5D arms 4 part 300 is unloaded from press 201, displaced towards the press 202, and loaded in press 202 with a substantially rectilinear trajectory in the direction of the press line and maintaining the orientation of the part 300 substantially constant during the transfer between presses 201, 202.

The elongated and relative thin (not bulky) construction of the distal end 4b of the arm 4 allows efficient and safe press loading and unloading operations, because the press only needs to open a small height, lower than prior solutions such as use of a crossbar. Moreover in the present developments only the arm 4 and gripper 5 would be damaged in case of accidental actuation of the press, while in the prior cases this situation would also damage the crossbar and may also damage the press, because the crossbar requires stiffer elements.

In all the possible operation modes, the actuation of the additional rotational axis A7 may compensate for the movement of the rotational axis A6 such that a part 300 may be moved following a substantially linear trajectory or path in the direction of the press line. The rotational movements of axis A6 and A7 which are controlled by the control unit/s 400 to follow opposite directions to each other keep the part 300 orientation.

The avoidance of interference between robots afforded by the system means that the inter-press distance can be reduced, minimizing the press-shop floor occupation space.

The control unit/s 400 operates axes A6, A7 in a fully synchronized way for coordinating the rotational movements of the rotational axis A6 and the additional rotational axis A7.

Furthermore the robot 101a, 101b may keep the orientation of the part 300 when transferring it from a station to the next one, and this also entails less risk of interference between robots 101a, 101b.

It should be noted that FIGS. 3 to 5 are merely schematic simulations of the movements of the robots and parts in a handling system as disclosed herein, and they may not show accurate positions of the robots, arms and parts in a real case.

Example of commercial serial robots that may be employed in systems such as disclosed herein are 6-axes robots such as IRB 6660, IRB 6650S, IRB 7600, or 4-axes robots such as IRB 660, IRB 760, all available from ABB (www.abb.com). The arm with the additional rotational axis would be fixed to the wrist of such a robot, that is, to the sixth axis or to the fourth axis, respectively, as disclosed above.

Although only a number of particular embodiments and examples of the inventions hereof have been disclosed herein, it will be understood by those skilled in the art that other alternative embodiments and/or uses of the inventions and obvious modifications and equivalents thereof are possible. Furthermore, the present inventions cover all possible combinations of the particular embodiments described. The scope of the present inventions should not be limited by particular embodiments, but should be determined only by a fair reading of the claims that follow.

1. A system for handling parts in a press line, the system comprising
two industrial robots and
at least one control unit for the control of the robots,
each industrial robot being an articulated robot with at least four axes mounted in series between a robot base and a robot wrist,
each industrial robot further comprising
an arm that has
a proximal end fixed to the robot wrist and
a distal end carrying an additional rotational axis,
a motor mounted on the arm near the proximal end, and
a transmission between the motor and the additional rotational axis.

2. A system as claimed in claim 1, each industrial robot being a four axes robot or a six axes robot.

3. A system as claimed in claim 1, the additional rotational axis in each robot being parallel to the robot wrist axis.

4. A system as claimed in claim 1, the dimension of the distal end of the arm, in the direction of the axis of rotation of the additional rotation axis, being smaller than the dimension of the proximal end of the arm.

5. A system as claimed in claim 1, the transmission comprising a transmission belt.

6. A system as claimed in claim 1, further comprising a gripper mounted on the additional rotational axis of each robot.

7. A system as claimed in claim 1, the at least one control unit being arranged to control the two robots jointly.

8. A system as claimed in claim 1, comprising two control units, one arranged to control each robot, and a device to synchronize the two control units.

9. A method for handling parts in a press line, the method comprising
providing two industrial robots and at last one control unit for the control of the robots,
each industrial robot being an articulated robot with at least four axes arranged in series between a robot base and a robot wrist,
each industrial robot further comprising
an arm that has a proximal end fixed to the robot wrist and a distal end carrying an additional rotational axis,
a motor mounted on the arm near the proximal end, and
a transmission between the motor and the additional rotational axis.

10. A method as claimed in claim 9, the at least one control unit operating the robots such that they jointly handle a part.

11. A method as claimed in claim 10, the at least one control unit operating the two robots to
jointly grip a part at a first station in a press line, and
jointly transfer the part to a second station in the press line.

12. A method as claimed in claim 9, the at least one control unit operating the two robots such that
one of the robots grips a first part at a first station in a press line and transfers the first part to a second station in the press line, and subsequently
the other robot grips a second part at the first station in the press line and transfers the second part to the second station in the press line,
each robot returning to the first station of the press line while the other transfers a part to the second station of the press line.

13. A method as claimed in claim 9, the at least one control unit operating the two robots such that
one of the robots grips a first part at a first station in a press line and transfers the first part to a second station in the press line, and substantially simultaneously
the other robot grips a second part at the first station in a press line and transfers the second part to the second station in the press line,
both robots returning substantially simultaneously to the first station of the press line.

14. A method as claimed in claim 9, comprising
controlling the robots to transfer a part from a first station to a second station of a press line with a gripper mounted on the additional rotational axis of each robot, and
controlling the additional rotational axis of each robot to place the gripper in position for gripping the part from the first station and to place the gripper in position for releasing the part in the second station.

15. A computer program product comprising program instructions for causing a computing system to perform a method according to claim 9.

16. A method for handling parts in a press line, comprising providing two industrial robots and at last one control unit for the control of the robots, each industrial robot being an articulated robot with at least four axes arranged in series between a robot base and a robot wrist, each industrial robot further comprising an arm that has a proximal end fixed to the robot wrist and a distal end carrying an additional rotational axis, a motor mounted on the arm near the proximal end, and a transmission between the motor and the additional rotational axis,
when the press line is stamping one part in each press, the at least one control unit operating the two robots either
such that they jointly grip a part at a first station in a press line, and jointly transfer the part to a second station in the press line; or
such that one of the robots grips a first part at a first station in a press line and transfers the first part to a second station in the press line, and subsequently the other robot grips a second part at the first station in the press line and transfers the second part to the second station in the press line, each robot returning to the first station of the press line while the other transfers a part to the second station of the press line; and
when the press line is stamping two or more parts in each press at the same time, the at least one control unit operating the robots such that one of the robots grips a first part at a first station in a press line and transfers the first part to a second station in the press line, and substantially simultaneously the other robot grips a second part at the first station in a press line and transfers the second part to the second station in the press line, both robots returning substantially simultaneously to the first station of the press line.
